(19) United States
(12) Patent Application Publication
(10) Pub. No.: US 2023/0391639 A1
(43) Pub. Date: Dec. 7, 2023

(54) METHOD FOR SOFTENING WATER WITH SPLIT-TYPE WATER SOFTENER

(71) Applicant: Yanfeng XU, Cixi (CN)

(72) Inventor: Yanfeng XU, Cixi (CN)

(21) Appl. No.: 17/812,661

(22) Filed: Jul. 14, 2022

(30) Foreign Application Priority Data
Jun. 3, 2022 (CN) 2022106266022

(51) Int. Cl. C02F 1/42

(52) U.S. Cl. CPC C02F 1/42; C02F 2303/16; C02F 2209/42; C02F 2201/005

(57) ABSTRACT

A method for softening water with a split-type water softener is provided. It includes S1, splitting the split-type water softener into a regenerator and a water maker; S2, disposing a softened water filter on the regenerator, and performing regeneration on the softened water filter to obtain a regenerated softened water filter; and S3, taking out the regenerated softened water filter, then disposing the regenerated softened water filter in the water maker, and softening water through the regenerated softened water filter to thereby obtain softened water for drinking, skin care, car washing, and other usages. The used filter replaced from the water maker is disposed on the regenerator to continue regeneration, so as to cycle. The method has strong practicability, good water softening effect, is simple to use, and can improve water softening efficiency and can save water softening time.

### TECHNICAL FIELD

The disclosure relates to the field of water softening treatment technologies, and more particularly to a method for softening water with a split-type water softener.

### BACKGROUND

Due to the volume limitation, softened water filters of the existing water softeners need to be regenerated repeatedly to ensure the normal use of the water softeners. Due to short regeneration time of the softened water filter, it is necessary to make a special valve head and set a complex procedure to regenerate resin of the softened water filter to ensure the effect of the regenerated resin. It usually takes 1-2 hours, and during regeneration, the water softener cannot soften the water, which not only affects quality of softened water, but also affects experience effects.

A Chinese patent application No.: 20161068490410.X, filed on Aug. 18, 2016, published on Dec. 14, 2016, and entitled “SOFTENED WATER RESIN REGENERATION CONTROL METHOD OF SOFTENED WATER PROCESSING DEVICE”. The patent document discloses a softened water resin regeneration control method of a softened water processing device. The method includes steps of setting a regeneration time point of a softened water resin in the time duration when a user does not use water, calculating the softened water resin regeneration judging time point according to the regeneration time point of softened water resin and the regeneration salt melting time, and judging whether regeneration is needed during softened water resin regeneration or not according to the residual water consumption Vsy and the daily average water consumption Vpj of the softened water processing device when the softened water processing device runs till the softened water resin regeneration judging time point. By means of the method, it is avoided that softened water resin loses efficacy, and the regeneration salt consumption can be saved.

The above patent document discloses the softened water resin regeneration control method of the softened water processing device, but the method for water softening is complex and not practical, the effect of water softening is not good, the water softening time is too long, and the efficiency is not high.

### SUMMARY

A main purpose of the disclosure is to propose a method for softening water with a split-type water softener, which has strong practicability, good water softening effect, is simple to use, and can improve the efficiency of water softening and can save water softening time.

In order to achieve the above purpose of the disclosure, the disclosure proposes a method for softening water with a split-type water softener, which includes the following steps:
step S1, splitting the split-type water softener into a regenerator and a water maker;
step S2, disposing a softened water filter on the regenerator, and performing regeneration on the softened water filter to obtain a regenerated softened water filter; and
step S3, taking out the regenerated softened water filter, then disposing the regenerated softened water filter in the water maker, and softening water through the regenerated softened water filter to thereby obtain softened water for drinking.

In an embodiment, the softened water filter includes a resin filter.

In an embodiment, at least one softened water filter is disposed in the regenerator for regeneration.

In an embodiment, in the step 2, the regenerator includes a salt dissolving tank and the softened water filter, the salt dissolving tank is connected to receive inlet water, a float configured to control a water level in the salt dissolving tank is disposed in the salt dissolving tank, a partition board configured to support regeneration salt is disposed in the salt dissolving tank, the water level in the salt dissolving tank is located over the regeneration salt, a bottom of the salt dissolving tank is connected to a water outlet pipe, the water outlet pipe is connected to the softened water filter, and the softened water filter is connected to a waste water pipe.

In an embodiment, the waste water pipe is disposed with a flow-limiting valve.

In an embodiment, the method further includes: after a softened water filter is saturated, disposing the saturated softened water filter on the regenerator after removing the saturated softened water filter from the water maker, conducting a water path, and thereby water in the salt dissolving tank flowing into the softened water filter under atmospheric pressure and then flowing out through the flow-limiting valve connected to the softened water filter.

The beneficial effects of technical solutions provided by the disclosure are as follows.
1) In the disclosure, the softened water filter is regenerated through the method for softening water with the split-type water softener, and then the softened water filter is taken out and disposed in the water maker to obtain softened water for drinking. The disclosure not only has a good softening effect, but also the method is simple to use, can be used repeatedly, and greatly improves softening efficiency.
2) The method of the disclosure has strong practicability. By splitting the water softener to soften water, the operation is practical and flexible, and the cost of water softening can be saved.
3) The disclosure is a technical upgrade of water softening treatment, which has a wide range of application scenarios and is suitable for general popularization.

### BRIEF DESCRIPTION OF DRAWINGS

In order to illustrate embodiments of the disclosure or technical solutions in the related art more clearly, drawings used in the description of the embodiments or the related art will be briefly introduced below. Apparently, the drawings in the following description are only some embodiments of the disclosure, for those skilled in the art, other drawings can be obtained according to structures shown in these drawings without paying creative labor.

FIG. 1 is a schematic flowchart of a method for softening water with a split-type water softener according to an embodiment of the disclosure.

FIG. 2 is a schematic structural diagram showing a regenerator used in the method for softening water with the split-type water softener according to the embodiment of the disclosure.

FIG. 3 is a schematic structural diagram showing a water maker used in the method for softening water with the split-type water softener according to the embodiment of the disclosure.

The realization of the objectives, functional features and advantages of the disclosure will be further described with reference to the accompanying drawings in combination with the embodiments.

### DETAILED DESCRIPTION OF EMBODIMENTS

Technical solutions of embodiments of the disclosure will be clearly and completely described below in combination with the accompanying drawings in the embodiments of the disclosure. Apparently, the described embodiments only are some embodiments of the disclosure, rather than all of embodiments of the disclosure. Based on the illustrated embodiments of the disclosure, all other embodiments obtained by those skilled in the art without creative work should belong to the scope of protection of the disclosure.

It should be noted that in the illustrated embodiments of the disclosure all directional indications (such as up, down, left, right, front, rear . . . ) are only used to explain relative positional relationships and motions among components under specific postures (as shown in the accompanying drawings). When the specific postures change, the directional indications will change accordingly.

In the disclosure, unless otherwise expressly specified and limited, terms “connected”, “disposed”, and the like should be interpreted in a broad sense. For example, “disposed” can be a fixed connection, a detachable connection, or integrated; it can be a mechanical connection or an electrical connection; it can be directly or indirectly connected through an intermediate medium; and it can be an internal connection of two elements or interaction between two elements, unless otherwise expressly limited. For those skilled in the art, the specific meanings of the above terms in the disclosure can be understood according to specific circumstances.

In addition, in the disclosure, the descriptions such as those involving “first” and “second” are only for descriptive purposes, and cannot be construed as indicating or implying their relative importance or implicitly indicating the number/quantities of indicated technical features. Thus, the features defined with “first” and “second” may explicitly or implicitly include at least one of such features. In addition, the technical solutions of various embodiments may be combined with each other, but only on the basis that they can be realized by those skilled in the art, and when the combination of technical solutions is contradictory or unrealizable, it should be considered that such combination of the technical solutions does not exist and is not within the scope of protection of the disclosure.

### Embodiment 1

The disclosure provides a method for softening water with a split-type water softener.

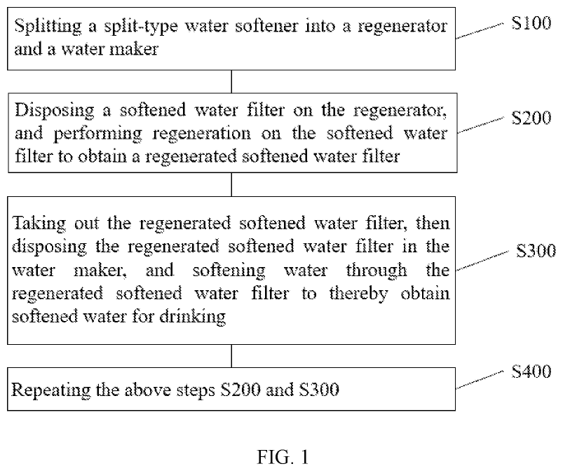

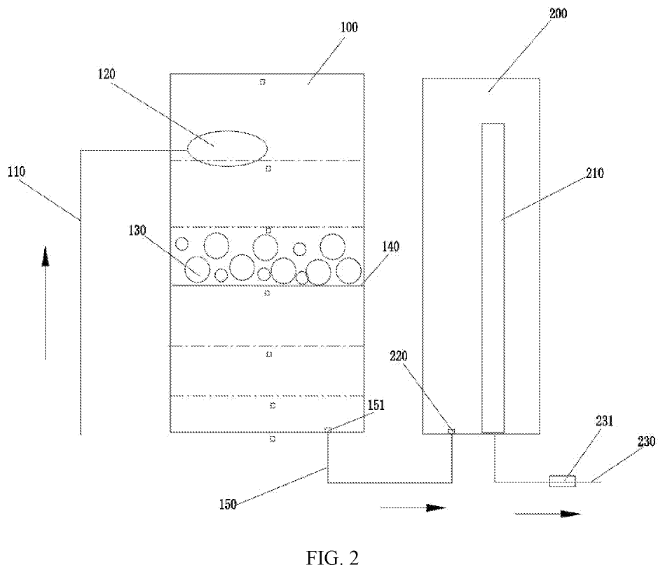

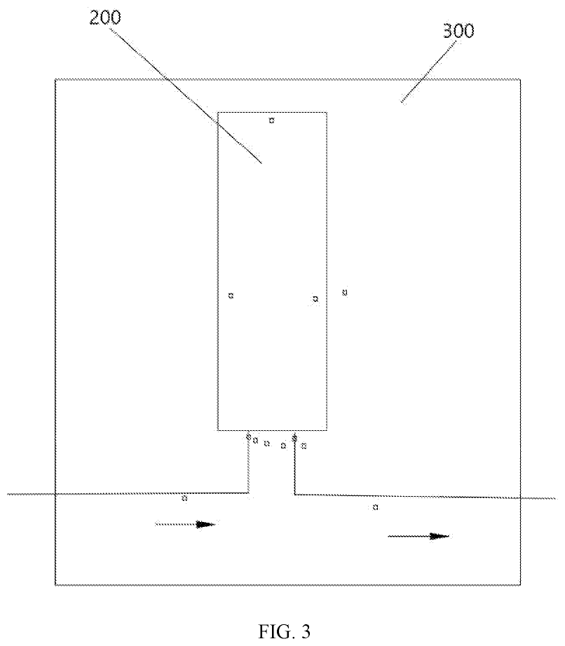

Referring to FIG. 1, FIG. 2, and FIG. 3, in some embodiments of the disclosure, the method for softening water with the split-type water softener may include the following steps.

Step S100, splitting the split-type water softener into a regenerator and a water maker 300.

Step S200, disposing a softened water filter 200 on the regenerator, and performing regeneration on the softened water filter 200 to obtain a regenerated softened water filter.

Step S300: taking out the regenerated softened water filter 200, then disposing the regenerated softened water filter 200 in the water maker 300, and softening water through the regenerated softened water filter 200 to thereby obtain softened water for drinking.

In an embodiment, use scenarios of the step S300 may include the drinking, skin care, car washing, and so on. In this case, the used filter replaced from the water maker is disposed on the regenerator to continue regeneration, so as to cycle.

Step S400, repeating the above steps S200 and S300.

Referring to FIG. 2 and FIG. 3, in the illustrated embodiment, the regenerator may include a salt dissolving tank 100 (also referred to as brine tank) and the softened water filter 200. In this embodiment, the softened water filter 200 includes a resin filter 210. The salt dissolving tank 100 may include a water inlet pipe 110, the salt dissolving tank 100 is connected to receive inlet water or a built-in independent water tank through the water inlet pipe 110. A mechanical float or an electric float 120 configured to control a water level in the salt dissolving tank 100 is disposed in the salt dissolving tank 100. A partition board 140 configured to support regeneration salt 130 (also referred to as softener salt blocks) is disposed in the salt dissolving tank 100. The water level in the salt dissolving tank 100 is located over the regeneration salt 130 to dissolve the regeneration salt 130 completely. A bottom of the salt dissolving tank 100 is disposed with a water outlet 151, the water outlet 151 is connected to a water outlet pipe 150, the water outlet pipe is connected to a water inlet 220 at an end of a bottom of the softened water filter 200, and another end of the bottom of the softened water filter 200 is connected to a waste water pipe 230.

In an embodiment, if there is no partition board in the salt dissolving tank, an actual salt consumption is calculated according to an actual algorithm, and quantitative salt blocks are directly added manually. The regenerator can also be equipped with a water inlet tank and a waste water tank, which can be made into an integrated regenerator without cumbersome water inlet connection.

In an embodiment, the waste water pipe 230 is disposed with a flow-limiting valve 231.

In an embodiment, at least one the softened water filter 200 is disposed on the regenerator for regeneration. Of course, according to actual needs, multiple softened water filters can be disposed on the regenerator to for regeneration. When the softened water filter 200 is taken out and disposed in the water maker to soften water, one softened water filter 200 can be replaced immediately after use. The regenerated softened water filter 200 is disposed in the water maker to soften water, which greatly improves the efficiency of water softening.

In an embodiment, the method further includes: after a softened water filter 200 is saturated, disposing the saturated softened water 200 filter on the regenerator after removing the saturated softened water filter from the water maker, conducting a water path, and thereby water in the salt dissolving tank 100 flowing into the softened water filter 200 under atmospheric pressure and then flowing out through the flow-limiting valve 231 connected to the softened water filter 200.

In the illustrated embodiment, when the resin filter 210 is saturated, the softened water filter 200 is removed and installed on the regenerator to conduct the water path. The water in the salt dissolving tank 100 flows into the softened water filter 200 under atmospheric pressure to replace calcium and magnesium ions in the softened water filter 200, and flows out through the flow-limiting valve 231 at the bottom of the softened water filter 200. Since the time of the flow-limiting valve 231 can be set (the flow rate of the wastewater is relatively small), the time to be replaced for the brine water in the softened water filter 200 is relatively long, and the ions can be fully replaced through the brine water, so that the regeneration of the softened water filter is better.

In the illustrated embodiment, the regenerated softened water filter 200 can be installed on the water maker for reuse, which improves the efficiency of water softening and greatly saves the time of water softening.

The softened water filter 200 can be set in a quick connection mode, or the water maker can be canceled and thus the softened water filter be directly connected to pipelines for use, or a connecting seat for the regenerator and the water maker can be set for installation and use.

The disclosure divides/splits the traditional water softener into a regenerator and a water maker, the softened water filter is disposed in the water maker to obtain the softened water. After the service life expires, the softened water filter is disposed on the regenerator for regeneration, and a spare filter is disposed in the water maker, and the softened water filter has enough time for full regeneration, which has no impact on user's use of the softened water, greatly simplifies the regeneration process, and simplifies the structure of the water softener.

The above description is only illustrated embodiments of the disclosure, and is not intended to limit the scope of protection of the disclosure. Without departing from the spirit and scope of the disclosure, various modifications and improvements can be made to the disclosure. Under the inventive concept of the disclosure, all equivalent structural substitutions made based on the description and accompanying drawings of the disclosure, or direct/indirect applications of the illustrated embodiments in other relevant technical fields, should be included in the scope of protection of the disclosure.

What is claimed is:

1. A method for softening water with a split-type water softener, comprising:
step 1, splitting the split-type water softener into a regenerator and a water maker;
step 2, disposing a softened water filter on the regenerator, and performing regeneration on the softened water filter to obtain a regenerated softened water filter; and
step 3, taking out the regenerated softened water filter, then disposing the regenerated softened water filter in the water maker, and softening water through the regenerated softened water filter to thereby obtain softened water for drinking.

2. The method according to claim 1, wherein the softened water filter comprises a resin filter.

3. The method according to claim 2, wherein at least one the softened water filter is disposed on the regenerator for regeneration.

4. The method according to claim 3, wherein in the step 2, the regenerator comprises a salt dissolving tank and the softened water filter, the salt dissolving tank is connected to receive inlet water, a float configured to control a water level in the salt dissolving tank is disposed in the salt dissolving tank, a partition board configured to support regeneration salt is disposed in the salt dissolving tank, the water level in the salt dissolving tank is located over the regeneration salt, a bottom of the salt dissolving tank is connected to a water outlet pipe, the water outlet pipe is connected to the softened water filter, and the softened water filter is connected to a waste water pipe.

5. The method according to claim 4, wherein the waste water pipe is disposed with a flow-limiting valve.

6. The method according to claim 5, further comprising: after a softened water filter is saturated, disposing the saturated softened water filter on the regenerator after removing the saturated softened water filter from the water maker, conducting a water path, and thereby water in the salt dissolving tank flowing into the softened water filter under atmospheric pressure and then flowing out through the flow-limiting valve connected to the softened water filter.
